(19) United States
(12) Patent Application Publication
(10) Pub. No.: US 2008/0281513 A1
(43) Pub. Date: Nov. 13, 2008

(54) Navigation apparatus, methods, and programs

(75) Inventor: Toru Sakai, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/076,726

(22) Filed: Mar. 21, 2008

(30) Foreign Application Priority Data
Mar. 30, 2007 (JP) 2007-091229

(51) Int. Cl. G01C 21/00; G06F 17/30

(52) U.S. Cl. 701/209; 701/200

(57) ABSTRACT

Apparatus, methods, and programs accept an area search condition that limits a facility search to facilities located within a specific position range. The apparatus, methods, and programs access stored facility data, the facility data including area information and position information for each facility in the stored facility data. Based on the stored area information, the apparatus, methods, and programs extract candidate facilities from the stored facility data that are located within an area that includes the specific position range and read out the position information for each of the extracted candidate facilities. Based on the read out position information, the apparatus, methods, and programs select the candidate facilities that are located within the specific position range for display.

### INCORPORATION BY REFERENCE

The disclosure of Japanese Patent Application No. 2007-091229, filed on Mar. 30, 2007, including the specification, drawings and abstract thereof, is incorporated herein by reference in its entirety.

### BACKGROUND

1. Related Technical Fields

Related technical fields include navigation apparatus and, for example, navigation apparatus that narrow a search to facilities that are located within a specific area.

2. Related Art

A navigation apparatus for searching for a route to a preset destination or a route to a preset stop-off point and providing the route to a driver is well known in the art. According to such navigation apparatus, when a specific point such as a destination or a point which a driver wants to stop at is input, a method for narrowing a search to candidate facilities among facilities which are in a database based on a search condition such as a search by Japanese alphabet or a search by category is used.

When the number of the candidate facilities cannot be reduced enough because there are a lot of facilities which match the search condition, a navigation apparatus disclosed in Japanese Unexamined Patent Application Publication No. 2007-40791 further limits the candidate facilities by adding the area as another search condition.

### SUMMARY

Navigation apparatus may include a data table for storing minimum information such as how to read, category code, area code, and the like, by facility IDs, in addition to a database for storing detailed information such as position coordinate, address, phone number, and the like, by facility IDs. By using the data table, it is possible to speed up the search by name (by Japanese alphabet), the search by category, and/or a search by address. According to the navigation apparatus disclosed in Japanese Unexamined Patent Application Publication No. 2007-40791, when facilities to be searched are limited to facilities which are located within a specific area among a lot of candidate facilities, candidate facilities which are targeted for limiting the search are searched by using the data table and coordinates of the all candidate facilities which are targeted for the limiting the search are read out from the database. Further, it is necessary to check each of the read coordinates of the all candidate facilities which have been read out from the database to area information of the specific area one by one.

For example, when a range within a R-kilometer radius from a specific reference point is specified as the specific area, the navigation apparatus has to calculate each distance from the specific reference point to all candidate facilities which are targeted for limiting the search on the basis of the coordinates which have been read out from the database. That is, when the facilities are limited to facilities that are located within the specific area, coordinate information of the all candidate facilities are read out from detailed facility information that is stored in the database, not from the data table. Therefore, the navigation apparatus has a heavy workload while the large number of candidate facilities is limited to the facilities that are located within the specific area. This results in slow search processing.

Accordingly, various exemplary implementations of the broad principles described herein reduce the processing workload for limiting a search to facilities that are located within a specific area.

Exemplary implementations provide apparatus, method, and programs that accept an area search condition that limits a facility search to facilities located within a specific position range. The apparatus, methods, and programs access stored facility data, the facility data including area information and position information for each facility in the stored facility data. Based on the stored area information, the apparatus, methods, and programs extract candidate facilities from the stored facility data that are located within an area that includes the specific position range and read out the position information for each of the extracted candidate facilities. Based on the read out position information, the apparatus, methods, and programs select the candidate facilities that are located within the specific position range for display.

### BRIEF DESCRIPTION OF THE DRAWINGS

Exemplary implementations will now be described with reference to the accompanying drawings, wherein:

FIG. 1 is a diagram showing an exemplary structure of a navigation apparatus;

FIG. 2A is a diagram showing an example of data records for search purposes;

FIG. 2B is a diagram showing an example of point information records;

FIG. 3A is a diagram showing an example of an area code table;

FIG. 3B is a diagram showing an example of a mesh code table;

FIG. 4 is a diagram showing an example of a mesh area;

FIG. 5 is a flowchart showing an exemplary destination search method;

FIG. 6A is a diagram showing an exemplary display of a limited search result of candidate destinations that are searched by name;

FIG. 6B is a diagram showing an exemplary screen for selecting a target narrowed search range when “surrounding area” is selected as an area search condition;

FIG. 6C is a diagram showing an example of a map screen to set a reference point;

FIG. 6D is a diagram showing an exemplary display of a facility list on which facilities within the narrowed search range are listed up;

FIG. 7A is a diagram showing an example of a relation between the narrowed search range and administrative areas; and

FIG. 7B is a diagram showing an example of a relation between the narrowed search range and mesh areas.

### DETAILED DESCRIPTION OF EXEMPLARY IMPLEMENTATIONS

When a specific point such as a destination, a point which a driver stops at, or a stop-off point (collectively means “destination”) is set, a navigation apparatus narrows a search range of candidate destinations on the basis of various types of search conditions and sets one destination based on the search result, that is, based on a candidate list. For example, candidate destinations are searched for by name or by category. However, when the number of the candidate destinations cannot be reduced enough, the search range is narrowed by area, so that only candidate facilities that are located within a specific area are extracted. According to the current example, the number of the candidate facilities is reduced by the search by name and further the search range is narrowed to an area (narrowed search range) whose center is a specific reference point and whose radius is N-kilometers, so that only candidate facilities that are located within the narrowed search range are extracted.

To extract the candidate facilities which are located within the narrowed search range, area codes of administrative areas and mesh codes of mesh areas (subdivision plat areas) which are both located within the specified narrowed search range are searched for. Next, data records of candidate facilities that were searched by name are checked with the searched area codes and the candidate facilities that belong to the administrative areas within the narrowed search range are extracted. Further, the data records of the candidate facilities that were extracted on the basis of the area codes are checked with the searched mesh codes and the candidate facilities that belong to the mesh areas within the narrowed search range are extracted. Then, the position coordinates of the candidate facilities that belong to the mesh areas within the narrowed search range are compared with the narrowed search range, and only the facilities that are located within the narrowed search range are finally searched.

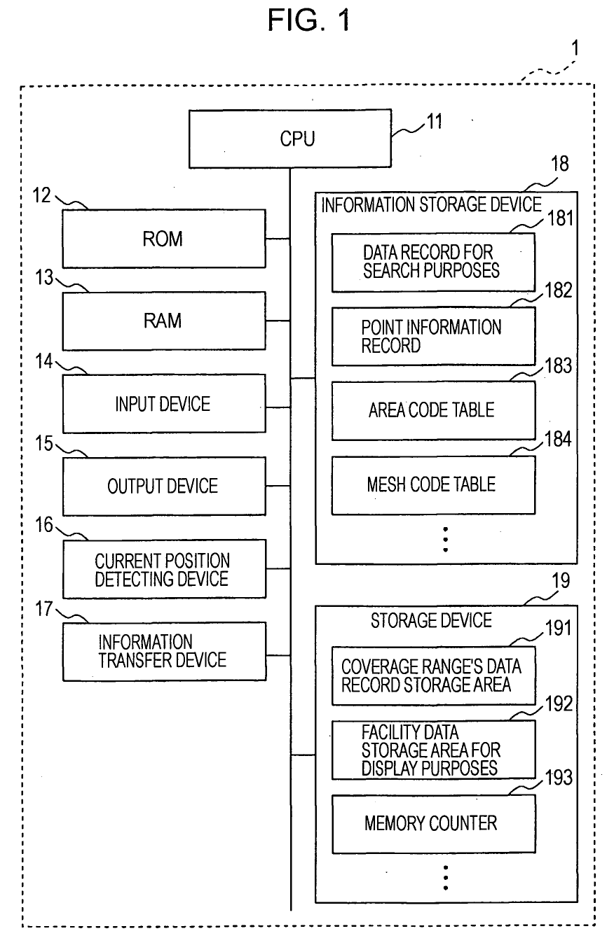

FIG. 1 is a diagram showing a structure of a navigation apparatus 1 in the current example. As shown in FIG. 1, the navigation apparatus 1 may include a controller (CPU 11), a ROM 12, a RAM 13, an input device 14, an output device 15, a current position detecting device 16, an information transfer device 17, an information storage device 18, and a storage device 19. The CPU 11 is a central calculating processing device for controlling the navigation apparatus 1 based on various programs and data that are stored in the ROM 12, the RAM 13, and/or the information storage device 18. The ROM 12 is a read only memory in which basic programs and/or basic parameters are stored for operating the navigation apparatus 1. The RAM 13 is a storage area that is a working area of the CPU 11. For example, the RAM 13 temporarily stores data in processing such as data according to an input search condition to narrow a search range.

The input device 14 is a device for directing the CPU 11 to perform a navigation processing on the basis of a user's physical input. For example, the input device 14 inputs information according to, for example, a destination (an address, a phone number, and/or position coordinate on a map of the destination), a point which the user wants to go through, a stop-off point, a search condition, or a search condition to narrow the search range, and/or a request for route guidance. According to the current example, the input device 14 may include a touch panel (touch screen), so that the user may touch a display screen (display) of the touch panel with his/her finger directly (pointing processing). However, the input device 14 may include a remote controller such as a jog dial.

The output device 15 is, for example, a device for outputting a processing result of the CPU 11 such as input information from the input device 14, route guidance information, a destination setting screen, a map screen on which an area surrounding a current position is shown, and/or various types of menu screens. According to the current example, the output device 15 may include a touch panel as the input device 14 to display various types of menu screens such as the destination setting screen, the map screen on which the area surrounding the current position is shown, or a narrow search range setting screen. However, a speaker for outputting the route guidance with audio guidance and/or a printer for printing processing data may be further included, separately.

The current position detecting device 16 detects a current position (the absolute coordinates in the latitude and the longitude) of a vehicle on which the navigation apparatus 1 is mounted and may include a GPS receiver for receiving information sent from a global positioning system (GPS) that detects position of vehicles using a satellite. Note that, the current position detecting device 16 may include a geomagnetic sensor for receiving a vehicle direction by detecting earth magnetism, a gyro sensor, and/or a vehicle speed sensor as a support device to support the current position detecting operation, which is performed by the GPS receiver. The information transfer device 17 may include a GPS receiver for obtaining a current position, a date and time, and/or time information using the global positioning system (GPS), a Vehicle Information and Communication System (VICS®) information transfer device for obtaining traffic information using an FM multiple broadcasting, an electric wave beacon, an optical beacon, and the like, and a data transfer device for exchanging information with an information center (for example, ATIS) and another vehicle using a mobile phone or a PC.

The information storage device 18 is an external storage device for storing programs and data for the navigation processing. As the information storage device 18, for example, a CD-ROM or a DVD-ROM may be used and data which is used for a destination searching processing program, a route search program, or a route guidance program, and data which is used for processing each of the programs may be stored in the information storage device 18. Specifically, search data that is used for a route search (for example, destination data, registered point data, road data, and category data) and guidance/display data (route guidance data, map display data, and map matching data which is used when a current position is detected) may be stored in the information storage device 18.

In the information storage device 18, a data record for search purposes 181, a map information record 182, an area record table 183, and a mesh code table 184 which are all used in the current example may be further stored.

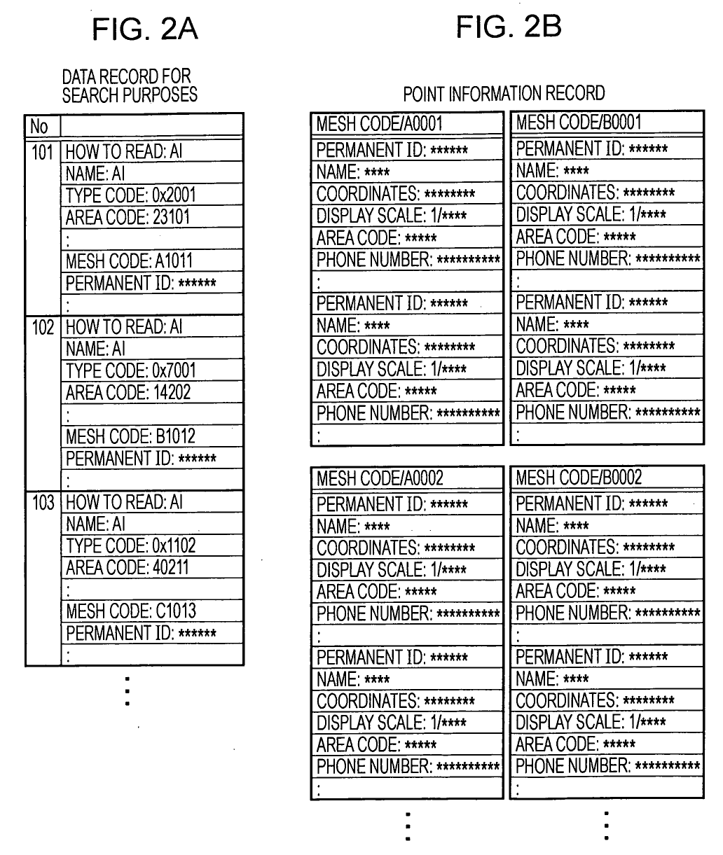

FIG. 2A is a diagram showing an example of the data record for search purposes 181. The data record for search purposes 181 is a data record that is used when a search range of candidate facilities is narrowed on the basis of search by name (by Japanese alphabet) or search by category. As shown in FIG. 2A, records (data) of each facility are stored (sorted) in the data record for search purposes 181 in the order of how to read. As the facility records, how to read, name, type code, area code, mesh code, and permanent ID are sorted and stored by facility in the data record for search purposes 181. Note that, the type code is an identifying code of a category (type) to which a facility belongs. The area code is an identifying code of an administrative area (city, ward, town, or village level). The mesh code is an identifying code of a mesh area that is subdivided into small areas. The permanent ID is an identifying code of the facility. The data record for search purposes 181 works as a first data table.

FIG. 2B is a diagram showing an example of the point information record 182. As shown in FIG. 2B, point information records of each facility are sorted and stored by mesh code in the point information record 182. Specifically, permanent ID, name, coordinates, display scale, area code, and phone number are stored by facility in the point information record 182. Note that, the coordinates indicate coordinates (the latitude and the longitude) of the position of the facility. The display scale is a map scale in which the facility can be displayed on a map. The point information record 182 works as a second data table.

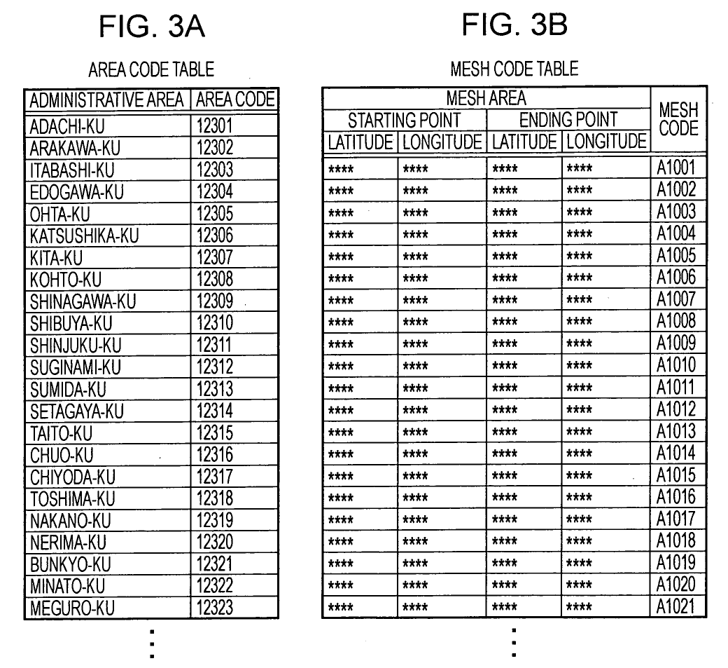

FIG. 3A is a diagram showing an example of the area code table 183. As shown in FIG. 3A, the area code table 183 is a data table in which administrative areas are related to area codes. Further, in the area code table 183, each area code is related to position information of administrative areas such as, for example, coordinate information that is provided by plotting administrative areas (indicating a border line between neighboring administrative areas).

FIG. 3B is a diagram showing an example of the mesh code table 184. As shown in FIG. 3B, the mesh code table 184 is a data table in which each mesh area is related to a mesh code.

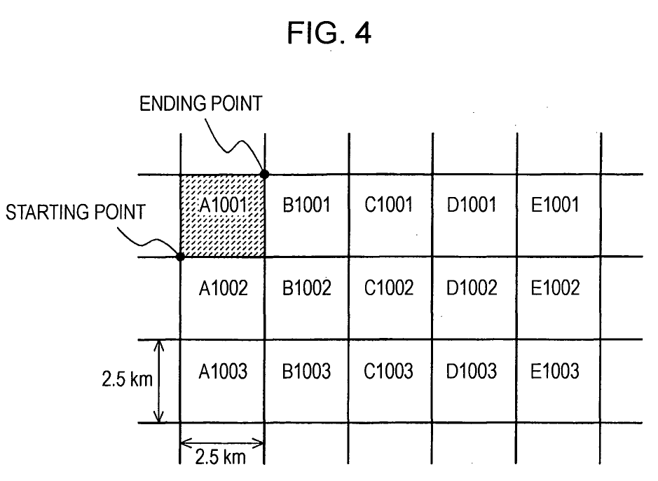

FIG. 4 is a diagram showing an example of the mesh area. As shown in FIG. 4, the mesh areas have no relation with the administrative areas and are small square areas (meshes), into which map data is subdivided. Each mesh area is much smaller than one administrative area (sectioned range). According to the current example, for example, one mesh area is a square, 2.5 km on a side. Note that, the size of one mesh area may be arbitrarily changed. Each mesh area is zoned in such a way that the borderlines between neighboring mesh areas are parallel to the latitude line and the longitude line. Therefore, each mesh area (a range which is zoned by the mesh) may be specified by obtaining one vertex and the opposite vertex of the square area, that is, each mesh area may be specified by obtaining coordinates of a starting point and an ending point (the latitude and the longitude) as shown in FIG. 4.

Returning to FIG. 1, the storage device 19 may include a coverage range's data record storage area 191, a facility data storage area for display purposes 192, and a memory counter 193, which are all used in the current example. In the coverage range's data record storage area 191, data records of facilities that are targeted for search by area are stored. In the facility data storage area for display purposes 192, display data of the facilities, which were limited by the search by area, are stored. The memory counter 193 is a counter for calculating the number of facilities that are stored in the facility data storage area for display purposes 192. According to the current example, a facility list, on which facilities within the narrowed search range are listed, is displayed on one screen of the output device 15 (touch panel) the displayable number “n” of facilities at a time on the basis of the memory counter value of the memory counter 193. Note that, according to the current example, the displayable number “n” of facilities on one screen is set as “5.” However, the displayable number “n” is not limited to “5.” and may be changed according to a display screen size and/or a display character size.

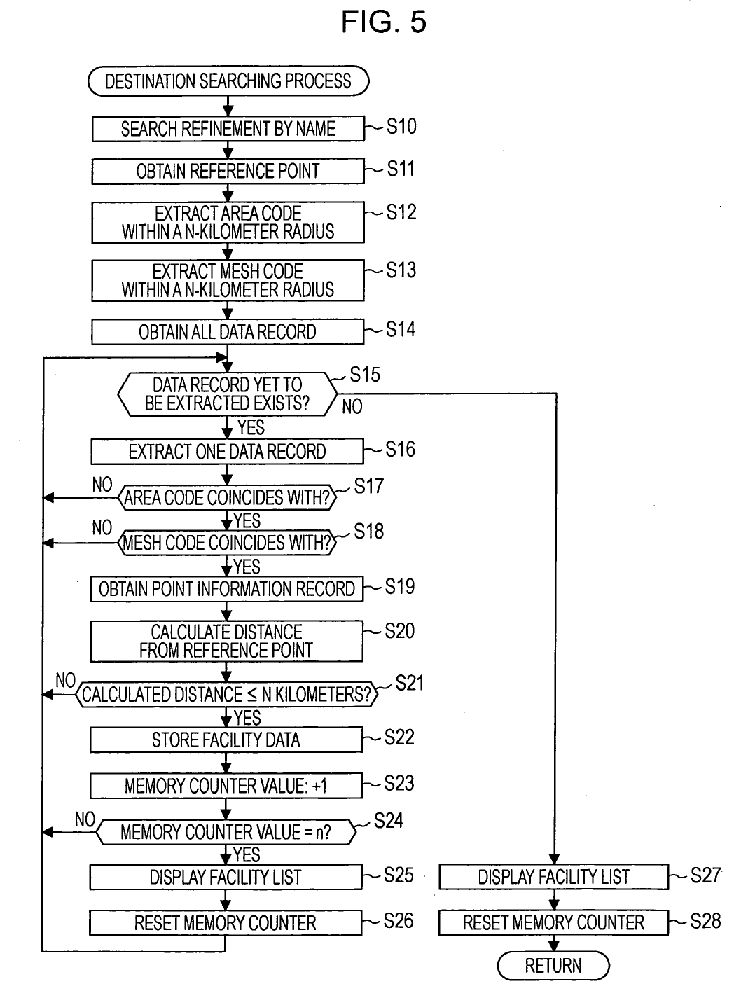

Next, an exemplary method of narrowing the search range of candidate destinations such as a goal, a point which the driver wants to go through, and/or a stop-off point (hereinafter referred to as destination) which are all set (input) will be described with reference to FIG. 5. The exemplary method may be implemented, for example, by one or more components of the above-described navigation apparatus 1. For example, the method may be implemented by the CPU 11 executing a program stored in the ROM 12. However, even though the exemplary structure of the above-described navigation apparatus 1 may be referenced in the description, it should be appreciated that the structure is exemplary and the exemplary method need not be limited by any of the above-described exemplary structure.

As shown in FIG. 5, first, the CPU 11 reduces the number of candidate destinations using the search by name (Step 10). Specifically, for example, when a keyword input screen for narrowing the search range using the search by name is displayed, a user operates a character input screen, which is displayed on the touch panel. For example, when the user inputs “AI” as a string of characters for searching for a destination, the CPU 11 accepts the input string of characters “AI” as a keyword which is used for the search by name. The CPU 11 searches for facility records whose “how to read” matches the keyword which was accepted for the search by name from data record for search purposes 181 stored in the information storage device 18. The search result is displayed on the touch panel.

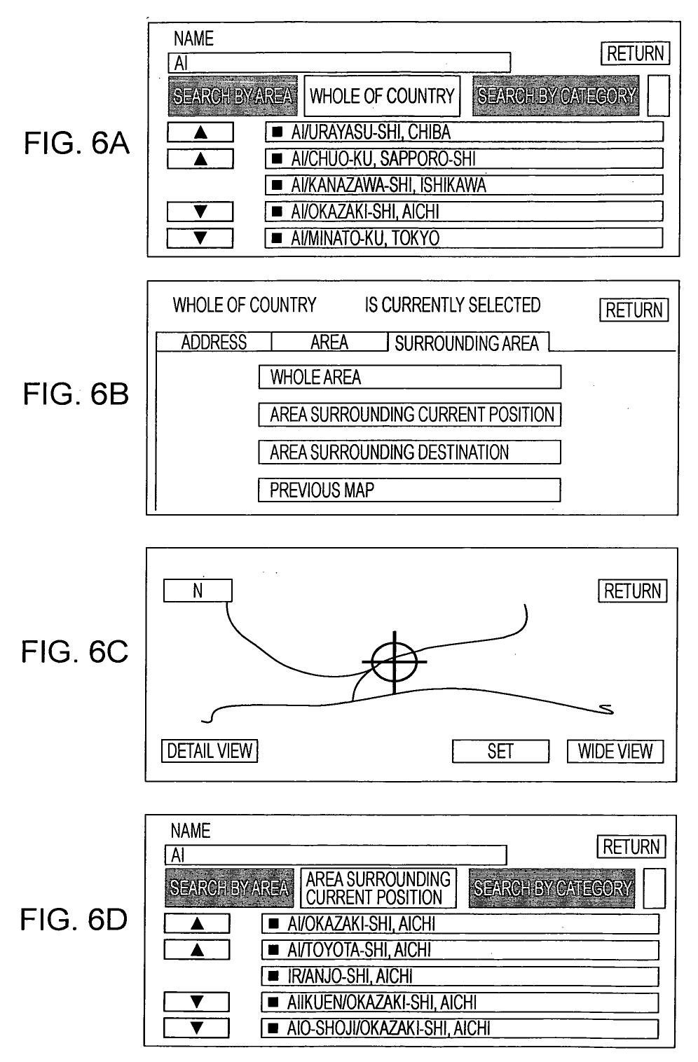

FIG. 6A is a diagram showing an example of the display of the searching result for reducing the number of candidate destinations by search by name. As shown in FIG. 6A, facility information such as names and rough addresses (city, ward, town, or village level) of the searched facilities are displayed as the search result of the candidate destinations on the basis of the search by name. Note that, even when only a part of facility information is displayed on one screen, operating a scroll bar, which is displayed on the touch panel, may allow the display of the rest of facility information.

When the number of candidate destinations cannot be reduced enough by the search range narrowing processing on the basis of the search by name which were described above, the navigation apparatus 1 of the current example may further narrow the search range of the candidate destinations using the area search condition. When the user touches a “search by area” key on the display screen in which the search result of the search by name has been displayed as shown in FIG. 6A, the CPU 11 further executes the search range narrowing processing on the basis of the search by area. FIG. 6B is a diagram showing a selecting screen for the narrowed search range while the search condition by area “surrounding area” is selected. When the user touches the “search by area” key and selects a tab which indicates the search condition by area “surrounding area” displayed on the touch panel, the CPU 11 displays the selecting screen of the narrowed search range on the touch panel as shown in FIG. 6B.

As shown in FIG. 6B, in the screen for selecting the narrowed search range, some options such as “whole area,” “area surrounding current position,” “area surrounding destination,” and “previous map” are set for selecting the search range. The “whole area” key is for resetting the search conditions that are currently used (that is, for resetting the current screen) for the narrowed search range. The “area surrounding current position” key is for limiting to facilities which are located within a range whose center is the current position (the reference point) and whose radius is N-km (for example, 10 km). The “area surrounding destination” key is displayed only when a travel route is set in advance and when a point that the driver wants to go through or a stop-off point is set. The “area surrounding destination” key is for limiting to facilities which are located within a range whose center is the ending point of the set route (destination) and whose radius is N-km (for example, 10 km). Note that, the radius N of the narrowed search range may be arbitrarily set. The “previous map” key is for limiting to facilities that are located within a map that was displayed on the touch panel last time.

According to the current example, an example of narrowing the search range by area, that is, a case when only facilities that are located within an area surrounding the current position are searched for will be described. When the user touches “area surrounding current position” key on the display screen on which the search result of the search condition by name is displayed as shown in FIG. 6B, the CPU 11 obtains information according to the current position from the current position detecting device 16. FIG. 6C is a diagram showing an example of a map screen that is for setting the reference point. The CPU 11 displays the map screen of the area surrounding the current position on the touch panel on the basis of the obtained information according to the current position as shown in FIG. 6C. The center position of a crosshair pointer that is displayed on the map screen indicates the reference point as shown in FIG. 6C. The reference point can move to any position on the screen according to the operation on the touch panel. When the user touches “set” key on the screen, the CPU 11 obtains the center position of the crosshair pointer that is displayed on the map screen at the touching the “set” key by the user as the reference point (Step S11).

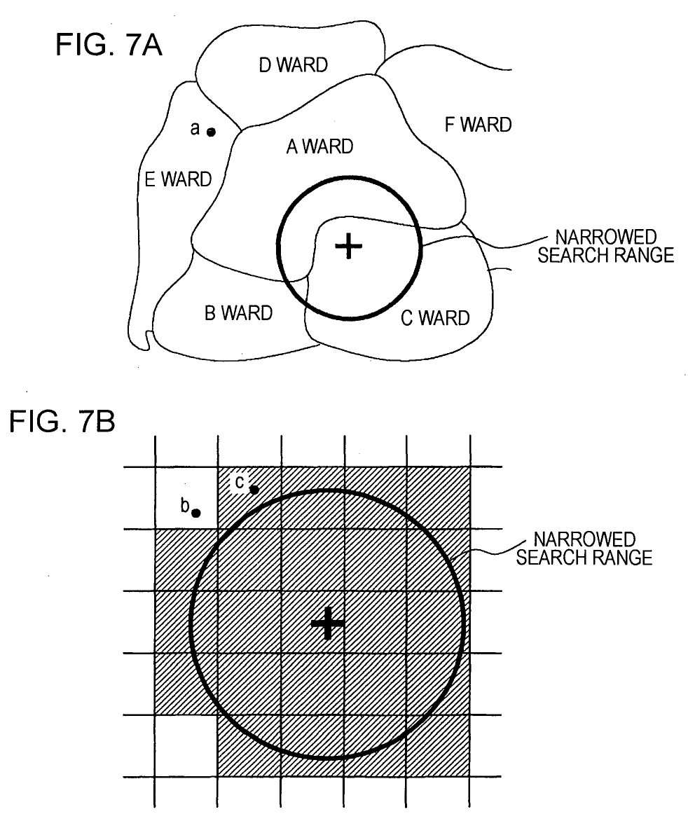

Next, the CPU 11 extracts the area codes of the administrative areas in which the range whose center is the obtained reference point and whose radius is N-km (hereinafter referred to as the narrowed search range) is included (Step S12) on the basis of position information of the administrative areas which are listed in the area code table 183. The CPU 11 stores the extracted area codes in the RAM 13. FIG. 7A is a diagram showing an example of a relation between the narrowed search range and the administrative areas. For example, when the narrowed search range is set as shown in FIG. 7A, the CPU 11 extracts the area codes of A ward, B ward, and C ward.

The CPU 11 further extracts mesh codes of the mesh areas in which the range whose center is the obtained reference point and whose radius is N-km is included on the basis of mesh area information of the mesh code table 184 (Step S13). The CPU 11 stores the extracted mesh codes in the RAM 13. FIG. 7B is a diagram showing an example of the relation between the narrowed search range and the mesh areas. For example, when the narrowed search range is set as shown in FIG. 7B, the CPU 11 extracts the mesh codes of the mesh areas marked with diagonal lines.

The CPU 11 next obtains data records of all target facilities for narrowing the search from the data record for search purposes 181 (Step S14). The CPU 11 stores the obtained data records in the coverage range's data record storage area 191. According to the current example, the data records of the facilities which are stored in the coverage range's data record storage area 191 are extracted one by one and processed one by one. All target facilities for limiting the search here indicate all facilities that are limited by the search by name as described above. That is, the obtained data records here are the same data records of facilities that correspond to the search result of the candidate destinations by the search by name in FIG. 6A.

The CPU 11 determines whether any data record yet to be extracted exists in the coverage range's data record storage area 191 (Step S15). When such a facility data record that has not been extracted yet exists (Step S15=YES), the CPU 11 randomly extracts one data record from the coverage range's data record storage area 191 (Step S16). An extracting flag that indicates that the data with the extracting flag has been extracted is on the extracted data record, so that the extracted data record can be identifiable among the data records yet to be extracted. The method of extracting the data record is not limited to this. For example, one data record may be extracted in the order of Japanese alphabet. The CPU 11 determines whether the area code of the extracted data record matches with the area code that has been extracted in Step S12 (Step S17). For example, facilities within the area including the point A as shown in FIG. 7A are narrowed down by the above search condition. Namely, the facilities that are not in the specific searched range are excluded from the searched list.

When the extracted area codes match each other (Step S17=YES), the CPU 11 determines whether the mesh code of the extracted data record matches with the mesh code which has been extracted in the processing in Step 13 (Step S18). For example, by the determination by the CPU 11 described above, all facilities that are located at point “b” in FIG. 7B, that is, all facilities that are located within the mesh area in which the narrowed search range is not included are exempt from the search. When the mesh code of the extracted data record matches with the mesh code which has been extracted in Step S13 (Step S18=YES), the CPU 11 reads out the permanent ID of the extracted data record and obtains point information records of facility data which are related to the read permanent ID (Step S19). The CPU 11 stores the obtained point information records in the RAM 13. The CPU 11 reads out coordinate data of the facilities from the obtained point information records and calculates distances from the reference point to each of the facilities on the basis of the coordinate data (Step S20). The CPU 11 stores the calculated distances from the reference point to each of the facilities in the RAM 13.

The CPU 11 determines whether each of the calculated distances from the reference point to each of the facilities is equal to or shorter than N-km (the specified distance of the narrowed search range), that is, whether the facilities are located within the narrowed search range (Step S21). For example, all facilities that are located at point “c” in FIG. 7B are exempt from the search because even though the facilities that are located at point “c” are located within the mesh areas in which a part of the narrowed search range is included, the facilities are not included within the narrowed search range itself. When the calculated distance is equal to or shorter than N-km (Step S21=YES), the CPU 11 stores the facility's data record in the facility data storage area for display purposes 192 (Step S22). Then the CPU 11 adds “1” to the memory counter value of the memory counter 193 (Step S23). The CPU 11 further determines whether the memory counter value of the memory counter 193 reaches the displayable number “n” (=5) of facility which can be listed on the screen of the touch panel at one time (Step S24).

When the memory counter value reaches the displayable number “n” (=5) of facility which can be listed at one time (Step S24=YES), the CPU 11 displays the facility list, in which the facilities being located within the narrowed search range are listed, on the touch panel on the basis of the facility data records which are stored in the facility data storage area for display purposes 192 (Step S25). In the facility data storage area for display purposes 192, displaying flags which indicate that the data record with the displaying flag has been displayed are set on the data records of facilities which have been displayed in the facility list, so that the data records of the displayed facilities are identifiable among other data records yet to be displayed. Note that, the limiting search processing of the facility list on which facilities being located within the narrowed search range are listed up works as search range narrowing means performed by the CPU 11. FIG. 6D is a diagram showing an example of the display of the facility list on which the facilities being located within the narrowed search range are listed. As shown in FIG. 6D, according to the current example, names and rough addresses (city, ward, town, or village level) of the corresponding facilities are displayed as the facility list for the facilities that are located within the narrowed search range. The user may set the destination by selecting (touching) one desired facility from the facility list that is displayed on the touch panel and on which the facilities being located within the narrowed search range are listed up.

Note that, the facilities from the top to the “n”-th in the facility list which is stored in the facility data storage area for display purposes 192 are displayed on the touch panel first as the facility list of the facilities which are located within the narrowed search range as shown in FIG. 6D. The rest of the facilities in the facility list (the “n+1”-th facility and later) are not displayed yet. The rest of the facilities in the facility list are displayed after the user operates the scroll bar that is displayed on the touch panel. Specifically, according to the current example, the rest of the facilities in the facility list (the “n+1”-th facility and later) are displayed on the touch panel in terms of the structure. However, in fact, the rest of the facilities in the facility list are in standby state to be displayed until the user's request (the user's operation of the scroll bar).

The CPU 11 resets the memory counter value of the memory counter 193 to “0” (Step S26) and repeats the procedures from Step S15. Note that, any one of when the area codes do not match each other (Step S17=NO), when the mesh codes do not match each other (Step S18=NO), when the calculated distance is not equal to or shorter than N-km (Step S21=NO), or when the memory counter value does not reach the displayable number “n” of facility (Step S24=NO), the CPU 11 repeats the procedures from Step S15. When it is determined that there is no data record of facility yet to be extracted in Step S15 (Step S15=NO), that is, when extracting flags are set on all data records stored in the coverage range's data record storage area 191, the CPU 11 displays the rest of the facilities which have not been displayed on the touch panel yet even though such the facilities are listed in the facility list in which the facilities located within the narrowed search range are listed on the touch panel on the basis of data records of the facilities, for which the displaying flags are not set, stored in the facility data storage area for display purposes 192 (Step S27). The CPU 11 resets the memory counter value of the memory counter 193 to “0” (Step S28) and the method ends.

As described above, according to the current example, when the candidate facilities as the destination are limited by the search by name once and further limited by the search by specific area (the narrowed search range), the processing of comparing the position coordinates of the facilities with the narrowed search range are performed only to the candidate facilities which are limited on the basis of the area codes and the mesh codes. Compared to the conventional way in which the processing is performed to all candidate facilities, the processing are performed only to a part of the candidate facilities, so that it is possible to limit only the facilities which are located within the narrowed search range. Therefore, it is possible to speed up the search range narrowing processing of the candidate facilities.

According to the current example described above, the processing of comparing the position coordinates of the facilities with the narrowed search range are performed only to the candidate facilities that are limited on the basis of the area codes and the mesh codes. However, the method for extracting the candidate facilities that are targeted for the processing of comparing the coordinates of the facilities with the narrowed search range need not be so limited. For example, it may be possible to perform the processing of comparing the position coordinates of the facilities with the narrowed search range only to the candidate facilities (the extracted candidate facilities) that are limited on the basis of only the area codes. Alternatively, it may be possible to perform the processing of comparing the coordinates of the facilities with the narrowed search range only to the candidate facilities (the extracted candidate facilities) that are limited on the basis of only the mesh codes.

Specifically, when the candidate facilities which are targeted for the comparing processing are limited (extracted) on the basis of only the area codes, the procedures in Steps S13 and S18 of the flowchart of the destination searching processing described above are not performed. That is, in Step S17, when the area code of the extracted data record matches with the area code that has been extracted in the procedure of Step S12 (Step S17=YES), the procedure goes to Step S19. Meanwhile, when the candidate facilities which are targeted for the comparing processing are limited (extracted) on the basis of only the mesh codes, the procedures in Steps S12 and S17 of the flowchart of the destination searching processing described above are not performed. That is, after the data records are extracted in Step S16, the procedure goes to Step S18. As described above, when the candidate facilities are extracted on the basis of either one of the area codes or the mesh codes, both the area code data table and the mesh code data table may not be necessary.

According to the current example, the narrowed search range for limiting only to the candidate facilities within the narrowed search range is a circle whose center is the specified reference point and whose radius is N-km. However, the shape of the narrowed search range need not be so limited. For example, an arbitrary shape such as a triangle, a polygonal shape including a square, or a range that is specified by the user may be used. Note that, when the narrowed search range is not a circle whose center is the specific reference point, the processing for determining whether the facilities are located within the narrowed search range, the processing is performed for the all facilities which are located within the mesh areas in which the narrowed search range is included, is performed by directly comparing the coordinates of the facilities with the narrowed search range.

According to the current example, the candidate facilities that have been limited by the search by name are target facilities for the extracting processing (limiting processing) of the facilities that are located within the specific narrowed search range. However, the target facilities need not be so limited. For example, the candidate facilities that are limited by another search condition such as the search by category or the search by phone number may be set as the target facilities.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A navigation apparatus for displaying candidate facilities in response to a facility search, comprising:
a memory that stores facility data, the facility data including area information and position information for each facility in the stored facility data; and
a controller that:
accepts an area search condition that limits a facility search to facilities located within a specific position range;
based on the stored area information, extracts candidate facilities from the stored facility data that are located within an area that includes the specific position range;
reads out the position information for each of the extracted candidate facilities; and
based on the read out position information, selects the candidate facilities that are located within the specific position range for display.

2. The navigation apparatus according to claim 1, wherein for each facility in the stored facility data, the stored area information comprises at least one of:
administrative area information indicating an administrative area in which the facility is located; and
mesh information indicating a mesh in which the facility is located.

3. The navigation apparatus according to claim 2, wherein the controller:
extracts the candidate facilities based on the administrative area information; and
narrows the candidate facilities based on the mesh information by excluding facilities that are located in a mesh that is outside of the specific position range from the candidate facilities.

4. The navigation apparatus according to claim 1, wherein the specific position range is centered on a specific reference point.

5. The navigation apparatus according to claim 4, wherein the specific position range is a range from the specific reference point to a predetermined distance.

6. The navigation apparatus according to claim 4, wherein the specific position range is a range defined by a predetermined shape centered on the specific reference point.

7. The navigation apparatus according to claim 4, wherein the controller:
accepts an input defining the specific reference point.

8. The navigation apparatus according to claim 4, wherein the specific reference point is at least one of:
a current position of the navigation apparatus;
a destination of a route for which the navigation apparatus is providing guidance;
a point on a map most recently displayed by the navigation apparatus; and
an arbitrary point set by a user.

9. The navigation apparatus according to claim 1, wherein:
before accepting the area search condition, the controller accepts a search condition that limits the facility search to facilities having a certain character in a facility name.

10. The navigation apparatus according to claim 1, wherein:
before accepting the area search condition, the controller accepts a search condition that limits the facility search to facilities of a certain category.

11. A method for displaying candidate facilities on a navigation apparatus in response to a facility search, comprising:
accepting an area search condition that limits a facility search to facilities located within a specific position range;
accessing stored facility data, the facility data including area information and position information for each facility in the stored facility data;
based on the stored area information, extracting candidate facilities from the stored facility data that are located within an area that includes the specific position range;
reading out the position information for each of the extracted candidate facilities; and
based on the read out position information, selecting the candidate facilities that are located within the specific position range for display.

12. The method according to claim 11, wherein for each facility in the stored facility data, the stored area information comprises at least one of:
administrative area information indicating an administrative area in which the facility is located; and
mesh information indicating a mesh in which the facility is located.

13. The method according to claim 12, further comprising:
extracting the candidate facilities based on the administrative area information; and
narrowing the candidate facilities based on the mesh information by excluding facilities that are located in a mesh that is outside of the specific position range from the candidate facilities.

14. The method according to claim 11, wherein the specific position range is a range centered on a specific reference point.

15. The method according to claim 14, wherein the specific position range is a range from the specific reference point to a predetermined distance.

16. The method according to claim 14, wherein the specific position range is a range defined by a predetermined shape centered on the specific reference point.

17. The method according to claim 14, further comprising:
accepting an input defining the specific reference point.

18. The method according to claim 14, wherein the specific reference point is at least one of:
a current position of the navigation apparatus;
a destination of a route for which the navigation apparatus is providing guidance;
a point on a map most recently displayed by the navigation apparatus; and
an arbitrary point set by a user.

19. The method according to claim 11, further comprising:
before accepting the area search condition, accepting a search condition that limits the facility search to at least one of:
facilities having a certain character in a facility name; and
facilities of a certain category.

20. A computer-readable storage medium storing a computer-executable program usable to displaying candidate facilities in response to a facility search, the program comprising:
instructions for accepting an area search condition that limits a facility search to facilities located within a specific position range;
instructions for accessing stored facility data, the facility data including area information and position information for each facility in the stored facility data;
instructions for extracting, based on the stored area information, candidate facilities from the stored facility data that are located within an area that includes the specific position range;
instructions for reading out the position information for each of the extracted candidate facilities; and
instructions for selecting, based on the read out position information, the candidate facilities that are located within the specific position range for display.
